(19) United States
(12) Patent Application Publication
(10) Pub. No.: US 2008/0209405 A1
(43) Pub. Date: Aug. 28, 2008

(54) DISTRIBUTED DEBUGGING FOR A VISUAL PROGRAMMING LANGUAGE

(75) Inventors: Paul C. Roberts, Kirkland, WA (US); Andreas Ulbrich, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/680,555

(22) Filed: Feb. 28, 2007

(51) Int. Cl. G06F 9/44

(52) U.S. Cl. 717/129; 717/127

(57) ABSTRACT

A system for distributed debugging of a visual programming language computer application. The system includes an execution environment such as a runtime environment to execute a visual programming language computer application. The system also includes a debugging engine to manipulate execution of the a visual programming language application being debugged. Both the execution environment and the debugging engine offer data and methods over a network connection such that either a networked or local debugger user interface may debug the visual programming language computer application. The debugger user interface may be instantiated on a world wide web browser using a received image file representing the visual programming language application, the debugging state, and presentation logic. More than one debugger user interface may interact with the debugging engine at one, allowing distributed debugging of the visual programming language application.

### BACKGROUND

Computer applications are commonly developed by application developers using a typical development environment. Such a development environment generally includes a text editor, a compiler, and a debugger. The application developer uses the text editor to enter source code written in a development language such as C, C++, or C#. The compiler translates the computer source code to object code. Object code may be code or instructions directly executable by the computer's central processing unit. The object code may require further standard software modules to be linked in order to create an executable application.

During application development, errors, also known as bugs, may be introduced into the source code by the application developer. The application developer may wish to discover the source of the errors and correct the errors through a process known as debugging the source code.

The process of debugging begins with setting the compiler to produce debug object code during compilation. Such debug object code may have embedded symbols or other markers indicating an equivalency between a line of source code and object code. Additional information related to the symbols and the source code may be stored in an external file.

The debugger may then control execution of the compiled debug object code and the application developer may then pause execution of the compiled debug object code, step through the source code corresponding to the compiled debug object code, inspect the values of variables, and the like. The debugger allows the application developer to view and inspect each line of source code as it is executed giving the application developer an opportunity to determine the cause of bugs or errors.

This process of debugging is commonly used with textual programming languages such as C, C++, or C#. Textual programming languages are written in text and are debugged using textual debuggers such as that described above. In contrast, visual programming languages (VPLs) are programmed using a graphical user interface. An application developer creates computer programs or applications in a visual programming language by manipulating user interface elements corresponding to program elements using a graphical user interface (GUI).

Such program elements may have been developed by an application developer in a textual programming language for deployment and execution in an application environment such as the Microsoft Decentralized Software Services (DSS) environment. The application environment typically routes messages between program elements, evaluates the program elements as messages arrive at the specified input of the program element, sends messages from the program elements as a result of the evaluation of the program elements, and the like.

During application development, the program elements are available for a user to manipulate using a GUI. The GUI may be used by a user to draw the logic and dataflow of an application such that the resulting diagram resembles a conventional flowchart. However, in contrast to a conventional flowchart, the diagram does not abstractly represent the application and instead completely describes the functioning of the application.

Errors or bugs may also be introduced into an application created in a visual programming language. However, a typical debugger designed for a textual programming language may not debug applications created in a visual programming language environment due to the visual nature of the development language.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides distributed debugging services for a visual programming language. In one implementation, a debugging engine is disposed within a runtime execution environment. The execution environment and debugging engine provide the debugging state and debugging methods to one or more debugger user interfaces either connected locally or connected on a network.

The visual programming language debugging engine may further provide the debugging state and a set of debugging methods to the user interfaces. The user interfaces may then display the current debugging state and send network messages to call the debugging methods on the visual programming language debugging engine. The user interfaces may also poll the visual programming language debugging engine at regular intervals for debugging state updates or may subscribe to the debugging state via network services offered by the execution environment.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows an example of a computing device for implementing one or more embodiments of the invention.

FIG. 2 shows an example of a computer program described by a Visual Programming Language.

FIG. 3 shows an example implementation of a visual debugging engine executing in a visual programming language environment.

FIG. 4 shows an example debugging engine component.

FIG. 5 shows an example debugging method for performance by a debugging user interface.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a distributed debugging system for a visual programming language, the system described is provided as an example and not a limitation. As those skilled in the art will appreciate, the present examples are suitable for application in a variety of different types of distributed debugging system for a visual programming language.

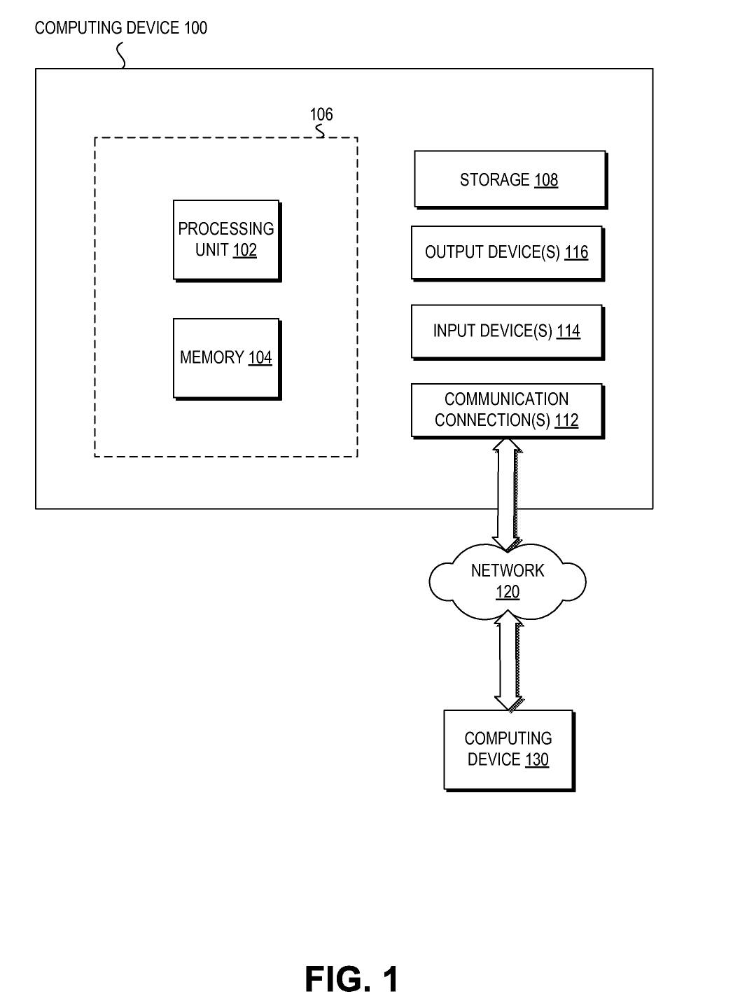

FIG. 1 and the following discussion are intended to provide a brief, general description of a suitable computing environment to implement embodiments of the invention. The operating environment of FIG. 1 is only one example of a suitable operating environment and is not intended to suggest any limitation as to the scope of use or functionality of the operating environment. Other well known computing devices, environments, and/or configurations that may be suitable for use with embodiments described herein include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments of the invention will be described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 1 shows an example of a computing device 100 for implementing one or more embodiments of the invention. In one configuration, computing device 100 includes at least one processing unit 102 and memory 104. Depending on the exact configuration and type of computing device, memory 104 may be volatile (such as RAM), non-volatile (such as ROM, flash memory, etc.) or some combination of the two. This configuration is illustrated in FIG. 1 by dashed line 106.

In other embodiments, device 100 may include additional features and/or functionality. For example, device 100 may also include additional storage (e.g., removable and/or non-removable) including, but not limited to, magnetic storage, optical storage, and the like. Such additional storage is illustrated in FIG. 1 by storage 108. In one embodiment, computer readable instructions to implement embodiments of the invention may be stored in storage 108. Storage 108 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 104 and storage 108 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also include communication connection(s) 112 that allow device 100 to communicate with other devices. Communication connection(s) 112 may include, but is not limited to, a modem, a Network Interface Card (NIC), or other interfaces for connecting computing device 100 to other computing devices. Communication connection(s) 112 may include a wired connection or a wireless connection. Communication connection(s) 112 may transmit and/or receive communication media.

Communication media typically embodies computer readable instructions or other data in a “modulated data signal” such as a carrier wave or other transport mechanism and includes any information delivery media. The term “computer readable media” may include communication media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 100 may include input device(s) 114 such as keyboard, mouse, pen, voice input device, touch input device, infra-red cameras, video input devices, and/or any other input device. Output device(s) 116 such as one or more displays, speakers, printers, and/or any other output device may also be included in device 100. Input device(s) 114 and output device(s) 116 may be connected to device 100 via a wired connection, wireless connection, or any combination thereof. In one embodiment, an input device or an output device from another computing device may be used as input device(s) 114 or output device(s) 116 for computing device 100.

Components of computing device 100 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 100 may be interconnected by a network. For example, memory 104 may be comprised of multiple physical memory units located in different physical locations interconnected by a network.

Those skilled in the art will realize that storage devices utilized to store computer readable instructions may be distributed across a network. For example, a computing device 130 accessible via network 120 may store computer readable instructions to implement one or more embodiments of the invention. Computing device 100 may access computing device 130 and download a part or all of the computer readable instructions for execution. Alternatively, computing device 100 may download pieces of the computer readable instructions, as needed, or some instructions may be executed at computing device 100 and some at computing device 130. Those skilled in the art will also realize that all or a portion of the computer readable instructions may be carried out by a dedicated circuit, such as a Digital Signal Processor (DSP), programmable logic array, and the like.

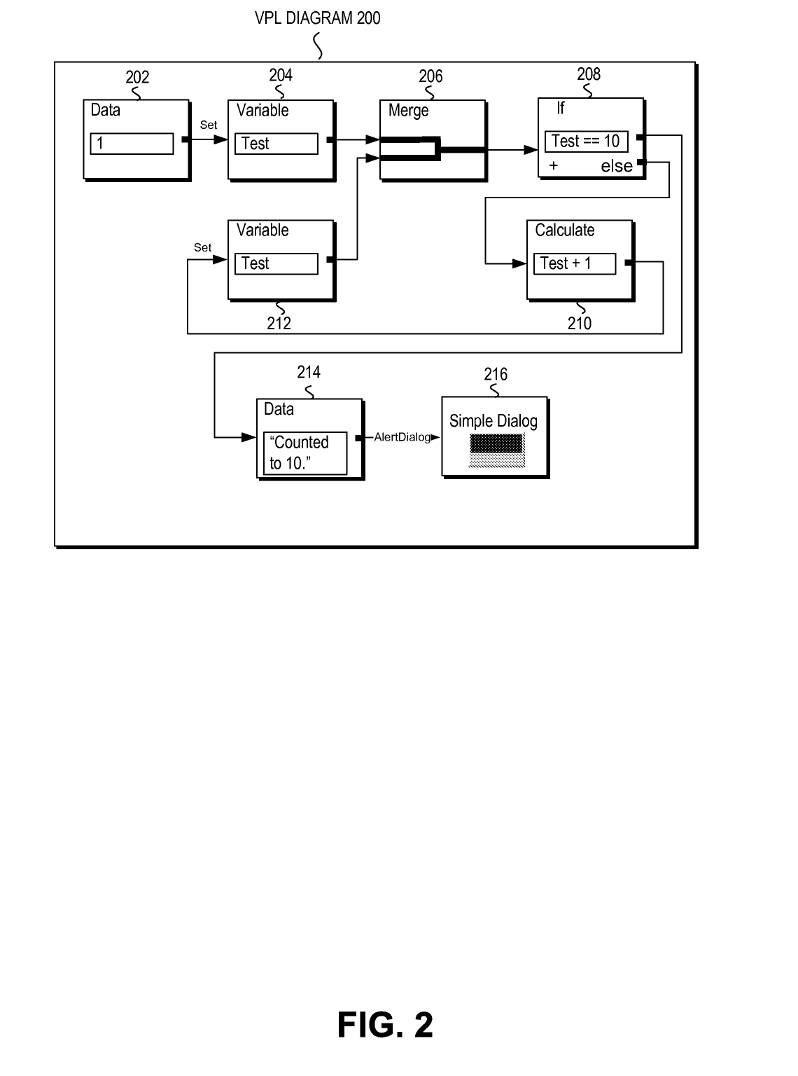

To provide a better understanding of the structure and functioning of a visual programming language, FIG. 2 shows an example diagram 200 of a computer program described by a visual programming language. The example diagram 200 includes a number of example program elements 202, 204, 206, 208, 210, and 212. The example program elements are illustrating as including “pins” to which arrows may be drawn to connect the example program elements. Such “pins” may represent different functions and may be set when the example diagram 200 was created in a development environment.

The computer program described by the example diagram 200 initializes a variable and sets the value of the variable to 1, tests the variable to determine if the variable is equivalent to 10, and if not, increments the variable. If the variable is equivalent to 10, a string is set to “counted to 10” and is passed to a program element functioning to display an alert dialog box displaying the string.

Within the example diagram 200, the example program element 202 is a “data” program element. A data program element creates a data value and sends the data value to the output pin. In the example program element 202, the data is the value “1”. The output pin of the example program element 202 is connected to the input pin of the example program element 204. The example program element 204 represents a variable named “Test” within the example diagram 200. The arrow representing the connection between the program element 202 and the program element 204 includes the word “Set” to indicate that the arrow is connected to the “set data” pin supported by the program element 204. Such a connection indicates that the variable named “Test” should be set to the value “1”.

The output pin of the program element 204 is connected to one input pin on the example program element 206. The function of the program element 206 is to “merge”, or, pass the value of each input pin untouched. The output pin of the program element 206 is connected to the input pin of the example program element 208. The function of the program element 208 is to perform an “if” comparison. The result of the “if” comparison is sent along the output pin, and, in this example, the output pin of the “if” comparison is connected to the input pin of the example program element 214. The program element 208 also includes and “else” statement that will execute should the “if” statement fail. The “else” statement includes a corresponding output pin. In this example, the output pin of the “else” statement is connected to the input pin of the example program element 210.

The function of the program element 210 is to “calculate” the current value of the variable “Test” and increment the value by 1. The output pin of the program element 210 is connected to the input pin of the example program element 212. The example program element 212 functions similarly to the example program element 204 in that the function of the example program element 212 is to set the value of the variable “Test” to the value received at the input pin. The output pin of the example program element 212 is connected to an input pin of the program element 206 so the value may be “merged”, or, passed unchanged.

Program execution ends when the “if” condition tested at the program element 208 fails and program flow continues along the output pin connected to the “else” condition to the input pin of the program element 214. The program element 214 functions similarly to the example program element 202, in that the program element 214 functions to create a data value and sends the data value including the string “Counted to 10” to the output pin of program element 214.

The output pin of the program element 214 is connected to the input pin of the example program element 216. In this example, the input pin of the program element 216 has been set to “AlertDialog” to indicate that the program element 216 should display a dialog box with the style “AlertDialog” and the text received from the output pin of the program element 214. Program execution ends at this point.

The example diagram 200 is illustrated as a standalone application; however, such an example diagram 200 may exist as a discreet unit of functionality. That is, the example diagram 200 may be considered to be a program element including input pin and output pin and may be used as part of a larger visual programming application.

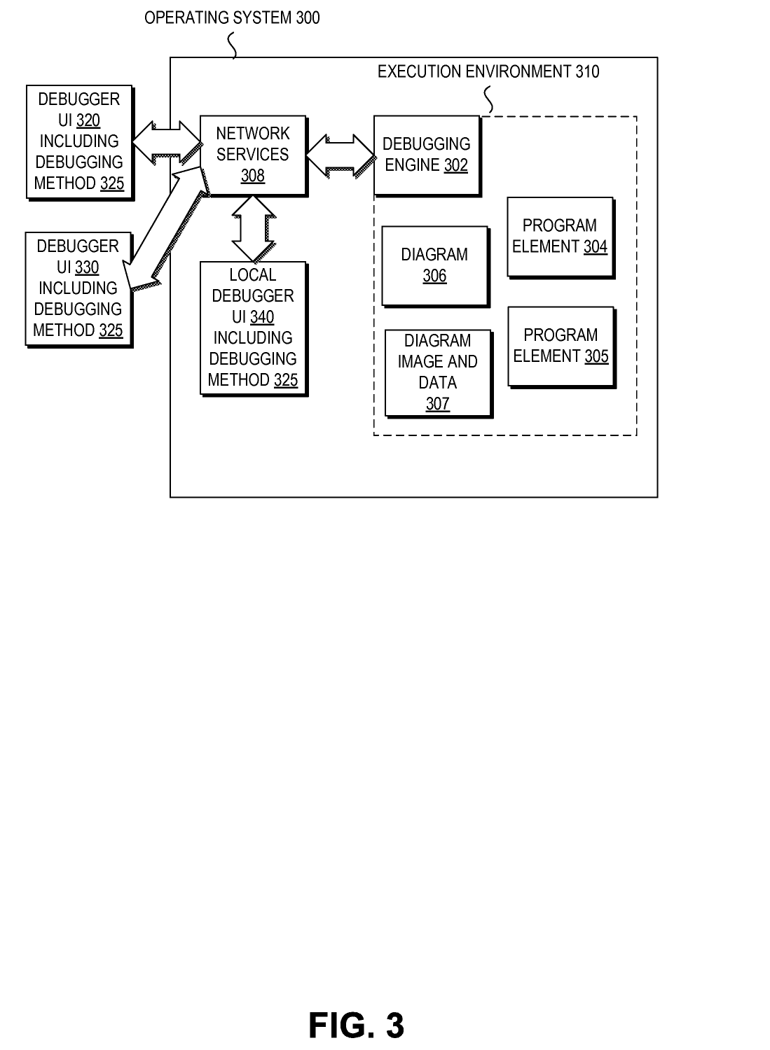

Turning now to FIG. 3, FIG. 3 shows an example implementation of a visual debugging engine 302 executing within a visual programming language execution environment 310. In an alternative example implementation, the functionality of the visual debugging engine 302 is disposed within the functionality of the execution environment 310. The execution environment 310 is executed within the operating system 300 that in turn executes in the example computing device 100 (from FIG. 1).

For illustrative purposes, the execution environment 310 includes an example visual programming language diagram 306. Such a visual programming language diagram 306 may be implemented as described with regard to FIG. 2. In an alternative implementation, the visual programming language diagram 306 may be stored within the operating system 300, within temporary storage, at a location on the network, or the like. The execution environment 310 further includes a visual representation of the diagram and associated data 307. While the visual representation of the diagram and associated data 307 is depicted as being included in the execution environment 310, such a depiction is for illustrative purposes only. The visual representation of the diagram and associated data 307 may be stored at any suitable location. The execution environment 310 also includes example program elements 304 and 305 that may be executed during execution of the visual programming language diagram 306.

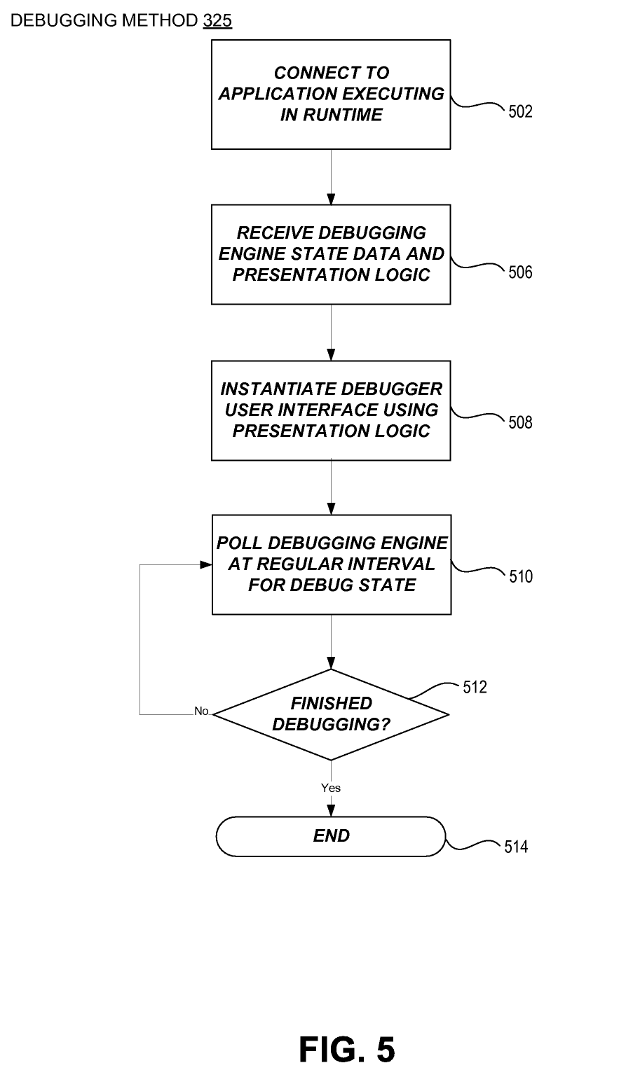

The debugging engine 302 is communicatively coupled to a network services component 308. In turn, network debugger user interfaces 320 and 325 and local debugger user interface 340 are each communicatively coupled to the network services component 308. The debugging engine 302 may send the debugging state and other associated information to any of the network debugger user interfaces 320 and 325 and the local debugger user interface 340 via the network services component 308. Conversely, any of the network debugger user interfaces 320 and 325 and local debugger user interface 340 may execute methods to modify the debugging state on the debugging engine 302 via the network services component 308. Each of the debugger user interfaces 320, 330, and 340 implements a debugging method 325 that will be discussed in further detail in the discussion of FIG. 5.

The network services component 308 provides network services such as web services, protocol services such as the hypertext transport protocol (HTTP), and the like. The network services component 308 also provides functionality for exchanging data messages using a communication protocol such as the simple object access protocol (SOAP), the decentralized software services protocol (DSSP) from Microsoft Corporation, and the like. In addition, the execution environment 310 and the debugging engine 302 may provide a public interface to local and network clients via the network services component 308.

The execution environment 310 executes visual programming language applications. The execution environment 310 receives an execution model of the application from a visual programming language editor or other computer application capable of creating and deploying a visual programming language application. An execution model may include, but is not limited to including, a list of program elements, connections between program elements, a description of the visual programming language application, information regarding other computer software services with which the visual programming language application communicates, and the like. Such execution model elements may be represented by the diagram 306 and program elements 304 and 305.

When the visual programming language application was created by the visual programming language editor, the visual programming language editor may have also sent the visual representation of the diagram and associated data 307. Such a graphical visual representation may be an image file such as a bitmap, or the like. Such associated data may include one or more unique identifiers representing one or more corresponding program elements. Such associated may include a mapping between the unique identifiers representing program elements in a visual programming language application and the graphical visual representation of the visual programming language application. Such a mapping includes a unique identifier of the program elements that may be included in the visual programming language application and the location or identify of each program element in the graphical visual representation. Such a location may be coordinates, a bounding box, or the like.

The debugging engine 302 may control and/or publish the debugging state of one or more visual programming language applications executing in the execution environment 310. The debugging engine 302 may be completely integrated into the execution environment 310 such that the debugging engine 302 is able to manipulate and inspect the execution of applications, modules, and the like within the execution environment 310. The public interface of the debugging engine 302 may include data fields including information regarding the current mode of execution, a queue of pending program elements to be executed, an identifier corresponding to the last executed program element, a list of breakpoints, and the like.

The public interface of the debugging engine 302 may further include methods providing functionality to step through the pending program elements in the queue, execute all pending program elements in the queue, halt execution of the pending program elements in the queue, execute pending program elements in the queue at a predetermined rate, set an execution breakpoint, clear an execution breakpoint, enable or disable a breakpoint, or the like. Debugger user interfaces 320, 330, and 340 may utilize functionality provided by either of the network services component 308 or the execution environment 310 to subscribe to the debugging engine and receive data from the data fields and execute methods to control the debugging engine 302.

Each of the debugger user interfaces 320, 330, and 340 may be a world wide web browser such as Microsoft Internet Explorer©. In an alternative embodiment, each of the debugger user interfaces 320, 330, and 340 may be a visual programming language editor. The debugging engine 302 may send a link or path to the a visual representation of the diagram and associated data 307 corresponding to the visual programming language diagram 306 or may be a link or path to the visual programming language diagram 306 itself. The debugging engine 302 may then send the debugging state as formatted data, for example, data formatted in the extensible markup language (XML). The debugging engine 302 may further send presentation information such as extensible stylesheet language (XSLT) instructions corresponding to the debug state. Such presentation information includes instructions to instantiate the debugger user interface on any of the debugger user interfaces 320, 330, and 340.

The presentation information includes instructions allowing the instantiated user interface to interpret the visual representation of the diagram and associated data 307. For example, the associated data of the visual representation of the diagram and associated data 307 may include data indicating the location of one or more program elements and the connections between the program elements. The presentation information may include instructions to properly interpret such locations and draw bounding boxes or the like around a currently executing program element. In the example where the debugger user interface is a visual programming language editor, the visual programming language editor may include instructions to properly interpret such locations and draw bounding boxes or the like around a currently executing program element.

The instantiated user interface provides a view of the visual programming language diagram 306 and user interface elements that allow a user to interact with the debugging engine 302. In one example, the instantiated user interface highlights, or draws a bounding box around the program element that will be executed next in the queue. The user may then interact with the user to interface to step through execution, break execution, set a breakpoint, and the like.

Each of the debugger user interfaces 320, 330, and 340 may connect to the debugging engine 302 concurrently. That is, each of the debugger user interfaces 320, 330, and 340 may call debugging methods implemented on the debugging engine 302 and the results of such method calls will be sent back to each of the debugger user interfaces 320, 330, and 340 in the form of the debugging state. In this way, debugging may be distributed amongst each of the debugger user interfaces 320, 330, and 340.

The instantiated user interface may subscribe to the debugging state published by the debugging engine 302 via the network services component 308. In an alternative embodiment, the instantiated user interface may poll the debugging engine 302 at a predetermined interval via the network services component 308. The debugging engine 302 may provide data representing the complete debugging state or may provide a reduced set of data representing only the change of the debugging state since the debugging state was last sent.

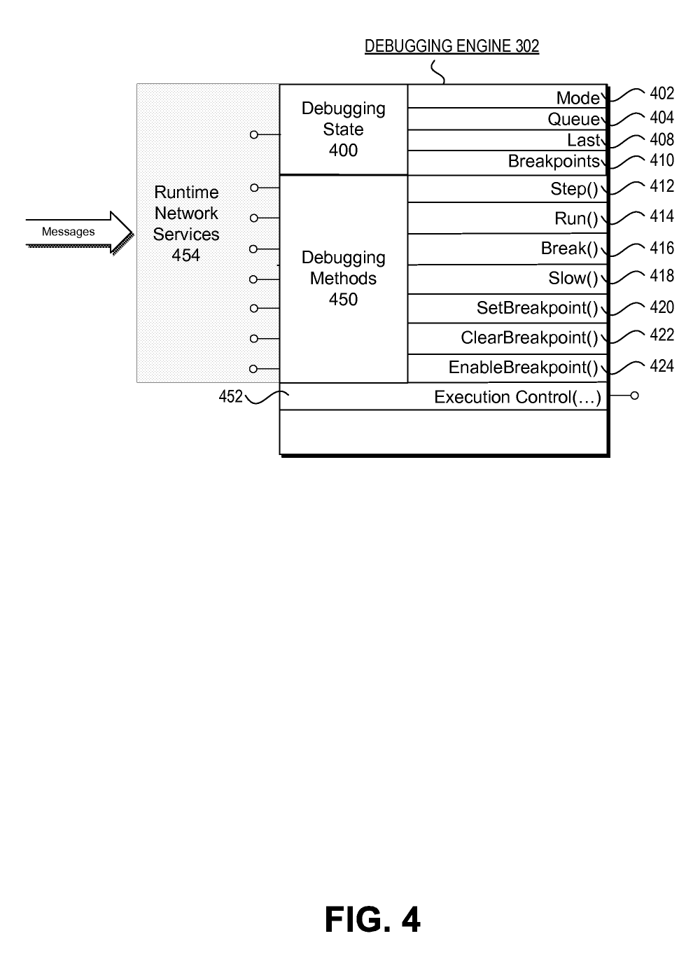

Turning now to FIG. 4, FIG. 4 shows an example debugging engine component 302 of FIG. 3. The debugging engine 302 may be implemented in any type of execution environment, for example, the Microsoft Component Object Model (COM), the Microsoft .Net Framework, Microsoft Robotics Studio runtime services, and the like. The debugging engine 302 may be a data structure that publishes the debugging state 400 and provides a set of public methods that may be executed. The debugging engine 302 may manipulate and control the execution of applications within the execution environment via execution control 452 functionality. Such execution control 452 includes functionality to inspect memory, control the pace of execution, and the like.

For example, the debugging engine 302 may include a debugging state 400 and a set of debugging methods 450. Each of the debugging state 400 and the debugging methods 450 may be manipulated by a client via runtime network services 454 implemented by the debugging engine 302. For example, if the debugging engine 302 is disposed in the Microsoft Robotics Studio runtime services system, the debugging engine 302 may implement each of the debugging state 400 and the debugging methods 450 as a service contract provided by the runtime network services 454.

The debugging state 400 may include the current mode 402 of the debugging engine 302, a queue 404 of program elements pending execution, and identifier of the last 408 program element executed, and a list of one or more breakpoints 410. The mode may indicate that the debugger is currently stepping through a visual programming language application, executing a visual programming language at full speed, executing a visual programming language application at a speed other than full speed, not debugging any visual programming language at all, and the like.

The debugging engine 302 also includes a set of public methods 450. For example, the debugging engine 302 may include a step method 412 that executes the first program element in the queue 404. The run method 414 executes all program elements in the queue 404, sets the current mode 402 to “running”. The break method 416 pauses execution of pending program elements in the queue 404 and sets the current mode 402 to “stepping”. The slow method 418 causes the debugging engine 302 to execute pending program elements in the queue 404 at a predetermined rate and sets the current mode 402 to “slow”.

The set breakpoint method 420 inserts a breakpoint that will pause execution of the application when the breakpoint is encountered in the queue 404. The clear breakpoint method 422 removes a breakpoint that has been inserted using the set breakpoint method 420. The enable breakpoint method 424 either enables a disabled breakpoint or enables a disabled breakpoint in the queue 402.

FIG. 5 shows an example debugging method 325 for performance by a debugging user interface.

Block 502 refers to an operation in a connection is established to the visual programming language that is being debugged. For example, a connection may be established by following a uniform resource identifier (URI) link to network services executing a visual programming language application. Flow continues to block 506.

Block 506 refers to an operation in which the current debugging state and any presentation logic is received. The current debugging state may include a link or path to the visual programming language application diagram of the application being debugged. Flow continues to block 508.

Block 508 refers to an operation in which the presentation logic is used to instantiate the user interface using the current debugging state received at block 506. Flow continues to block 510.

Block 510 refers to an operation in which the server is polled for the current debugging state at a predetermined time interval. In an alternative embodiment, a subscription may have been established with the server and such polling is unnecessary as the current debugging state is sent when necessary. Flow continues to block 512.

Block 512 refers to a decision to determine if the current debugging session has ended. The current debugging session may end in response to the last pending program element being executed, the user explicitly ending debugging, or any other operation that results in the termination of debugging. In response to a positive determination, flow continues on to block 514. In response to a negative determination, flow returns to block 510.

Block 514 refers to an operation in which the debugging method 325 terminates execution.

1. A system for distributed debugging of a visual programming language computer application, comprising:
An execution environment for executing instructions associated with the visual programming language computer application, the execution environment configured to provide network services; and
A debugging engine, the debugging engine configured to manipulate the execution of the instructions of the visual programming language application, the debugging engine further configured to send a debugging state using the network services and further configured to provide at least one debugging method using the network services.

2. The system as in claim 1, the system further comprising at least one debugger user interface to receive the debugging state.

3. The system as in claim 1, the system further comprising at least one debugger user interface to send a network message to call the at least one debugging method.

4. The system as in claim 1, wherein the debugging state includes the debugging mode.

5. The system as in claim 1, wherein the debugging state includes a queue of at least one visual programming program element that is pending execution by the execution environment.

6. The system as in claim 1, wherein the debugging state includes an identifier of at least one visual programming program element that was last executed by the execution environment.

7. The system as in claim 1, wherein the debugging state includes the location of a least one breakpoint identifying a visual programming program element at which execution by the execution environment will pause.

8. The system of claim 1, wherein the at least one debugging method instructs the execution engine to execute the visual programming language application.

9. The system of claim 1, wherein the at least one debugging method instructs the execution environment to execute a pending visual programming program element.

10. The system of claim 1, wherein the at least one debugging method instructs the execution environment to pause execution of the visual programming language application.

11. The system of claim 1, wherein the at least one debugging method instructs the execution environment to execute the visual programming language application at a predetermined rate.

12. The system of claim 1, wherein the at least one debugging method manipulates a breakpoint in the visual programming language application.

13. A method for distributed debugging of a visual programming language application, the method comprising:
sending a start message to a debugging engine to begin debugging the visual programming language application;
receiving an image file and data corresponding to the visual programming language application;
receiving information corresponding to a debugging state of the visual programming language application;
receiving presentation logic corresponding to the information corresponding to the debugging state;
instantiating a user interface using the presentation logic and the information corresponding to the debugging state; and
sending an debugging state update request message to the debugging engine.

14. The method of claim 13, wherein the start message is a uniform resource indicator (URI).

15. The method of claim 13, wherein the information corresponding to the debugging state of the visual programming language application is formatted in the extensible markup language (XML).

16. The method of claim 13, wherein the presentation logic is formatted in the extensible stylesheet (XSLT) language.

17. The method of claim 13, wherein the method is performed by a World Wide Web browser.

18. The method of claim 13, wherein the image file further comprises one or more graphical images corresponding to the visual programming language application and the data further comprises a mapping between one or more program elements of the visual programming language application and one or more corresponding locations within the image file.

19. A visual programming language debugging engine component, comprising:
data representing at least one debugging state; and
at least one debugging method to control execution of a visual programming language application executing in an execution environment; and
at least one network connection to receive request to send the at least one debugging state and to receive requests to execute the at least one debugging method.

20. The visual programming language debugging engine component of claim 19, wherein the execution environment is the Microsoft Robotics Studio runtime environment.
